(19) United States
(12) Patent Application Publication
(10) Pub. No.: US 2025/0030052 A1
(43) Pub. Date: Jan. 23, 2025

(54) SECONDARY BATTERY, BATTERY PACK, VEHICLE, STATIONARY POWER SUPPLY, AND METHOD OF PRODUCING SECONDARY BATTERY

(71) Applicant: KABUSHIKI KAISHA TOSHIBA, Tokyo (JP)

(72) Inventors: Keigo Hoshina, Yokohama Kanagawa (JP); Takuya Hatakeyama, Kawasaki Kanagawa (JP); Yoshiaki Murata, Kawasaki Kanagawa (JP); Yasuyuki Hotta, Tokyo (JP); Takashi Kuboki, Tokyo (JP)

(73) Assignee: KABUSHIKI KAISHA TOSHIBA, Tokyo (JP)

(21) Appl. No.: 18/589,706

(22) Filed: Feb. 28, 2024

(30) Foreign Application Priority Data
Jul. 21, 2023 (JP) 2023-119271

(51) Int. Cl. H01M 10/0568; H01M 4/02; H01M 4/131; H01M 4/133; H01M 10/052; H01M 10/0569; H01M 10/0587; H01M 50/509

(52) U.S. Cl. CPC H01M 10/0568; H01M 4/131; H01M 4/133; H01M 10/0569; H01M 10/0587; H01M 50/509; H01M 2004/027; H01M 10/052; H01M 2220/10; H01M 2220/20

(57) ABSTRACT

According to one embodiment, a secondary battery including a negative electrode, a positive electrode, and an electrolyte is provided. The electrolyte contains water, a lithium salt, and a phosphate ester. The electrolyte contains the water in an amount of 150 ppm or more and 30,000 ppm or less in terms of mass. The lithium salt includes at least one selected from a group consisting of lithium bis (trifluoromethanesulfonyl) imide, lithium bis (fluorosulfonyl) imide, lithium difluorooxalate borate, lithium bisoxalate borate, and lithium triflate.

### CROSS-REFERENCE TO RELATED APPLICATIONS

This application is based upon and claims the benefit of priority from Japanese Patent Application No. 2023-119271, filed Jul. 21, 2023, the entire contents of which are incorporated herein by reference.

### FIELD

Embodiments described herein relate generally to a secondary battery, a battery pack, a vehicle, a stationary power supply, and a method of producing the secondary battery.

### BACKGROUND

A nonaqueous electrolyte battery using a carbon material or a lithium titanium oxide as a negative electrode active material and a layered oxide that contains nickel, cobalt or manganese as a positive electrode active material, a lithium secondary battery in particular, has already been in practical use as a power source in a wide range of fields. Such a nonaqueous electrolyte battery is provided in a variety of forms, from small-sized batteries such as those for various electronic devices to large-sized batteries such as those for electric automobiles. For an electrolyte solution of the lithium secondary battery, a nonaqueous organic solvent prepared by mixing ethylene carbonate, methyl ethyl carbonate and the like is used, unlike a nickel-hydrogen battery or a lead storage battery. An electrolyte solution prepared using such a solvent has a high oxidation resistance and a high reduction resistance, whereby electrolysis of the solvent hardly occurs. Thus, with a nonaqueous lithium secondary battery, a high electromotive force of from 2 V to 4.5 V can be realized.

Meanwhile, many organic solvents are flammable substances. Accordingly, the safety of a secondary battery formed using an organic solvent is theoretically inferior to that of a nickel-hydrogen battery or lead storage battery. In order to improve the safety of a lithium secondary battery using an electrolyte solution containing an organic solvent, various countermeasures have been made; however, one cannot be certain that the countermeasures are sufficient. In addition, the production process of the nonaqueous lithium secondary battery requires a dry environment, thereby inevitably increasing the production cost. Moreover, the electrolyte solution containing an organic solvent is inferior in electrical conductivity, whereby an internal resistance of the nonaqueous lithium secondary battery is apt to increase. Such problems are great draw backs for applications in electric vehicles or hybrid electric vehicles and large-sized storage batteries for stationary energy storage, for which battery safety and cost are regarded to be of importance.

In order to solve the problem of nonaqueous secondary batteries, there has been proposal of making the electrolytic solution non-combustible. As a measure for making the electrolytic solution non-combustible, for example, there has been consideration making the electrolytic solution be an aqueous solution. However, with the electrolytic solution using water, reductive decomposition at the negative electrode is apt to occur, and thus, gas generation and cycle deterioration is apt occur. Therefore, suppression of the reductive decomposition of the electrolytic solution is a matter to be solved.

Known as a measure of suppressing reductive decomposition, for example, is increasing the concentration of a lithium salt to diminish water in the electrolytic solution. However, suppression of the reductive decomposition by the high-concentration electrolytic solution has not been sufficient.

### BRIEF DESCRIPTION OF THE DRAWINGS

FIG. 1 is a conceptual diagram illustrating a surface of a negative electrode in a conventional secondary battery.

FIG. 2 is a conceptual diagram illustrating a surface of the negative electrode in the secondary battery according to the embodiment.

FIG. 3 is a cross-sectional view schematically illustrating an example of the secondary battery according to the embodiment.

FIG. 4 is a cross-sectional view of the secondary battery illustrated in FIG. 3 taken along line IV-IV.

FIG. 5 is a cross-sectional view schematically showing another example of a secondary battery according to an embodiment.

FIG. 6 is an enlarged cross-sectional view of section A of the secondary battery shown in FIG. 5.

FIG. 7 is a partially cutaway perspective view schematically illustrating yet another example of the secondary battery according to the embodiment.

FIG. 8 is an enlarged cross-sectional view of a section B of the secondary battery illustrated in FIG. 7.

FIG. 9 is a perspective view schematically illustrating an example of a battery module according to an embodiment.

FIG. 10 is a perspective view schematically illustrating an example of a battery pack according to an embodiment.

FIG. 11 is an exploded perspective view schematically illustrating another example of the battery pack according to the embodiment.

FIG. 12 is a block diagram illustrating an example of an electric circuit of the battery pack illustrated in FIG. 11.

FIG. 13 is a cross-sectional view schematically illustrating an example of a vehicle according to an embodiment.

FIG. 14 is a block diagram illustrating an example of a system including a stationary power supply according to an embodiment.

### DETAILED DESCRIPTION

According to one embodiment, a secondary battery including a negative electrode, a positive electrode, and an electrolyte is provided. The electrolyte contains water, a lithium salt, and a phosphate ester. The electrolyte contains the water in an amount of 150 ppm or more and 30,000 ppm or less in terms of mass. The lithium salt includes at least one selected from a group consisting of lithium bis (trifluoromethanesulfonyl) imide, lithium bis (fluorosulfonyl) imide, lithium difluorooxalate borate, lithium bisoxalate borate, and lithium triflate.

According to another embodiment, a battery pack including the secondary battery according to the above embodiment is provided.

According to yet another embodiment, a vehicle including the battery pack according to the above embodiment is provided.

According to still another embodiment, a stationary power supply including the battery pack according to the above embodiment is provided.

Moreover, a method for producing the secondary battery according to the above embodiment is provided. The method includes preparing the negative electrode, preparing the positive electrode, preparing the electrolyte, preparing a container member, housing the negative electrode and the positive electrode in the container member, and putting in the electrolyte into the container member. The putting in the electrolyte is performed under an environment a dew point of −20° C. or more and 0° C. or less.

Hereinafter, embodiments will be described with reference to the drawings. The same reference signs are applied to common components throughout the embodiments and overlapping explanations are omitted. Each drawing is a schematic view for explaining the embodiment and promoting understanding thereof; though there may be differences in shape, size and ratio from those in an actual device, such specifics can be appropriately changed in design taking the following explanations and known technology into consideration.

### First Embodiment

According to a first embodiment, there is provided a secondary battery including a negative electrode, a positive electrode, and an electrolyte. The electrolyte contains water, a lithium salt, and a phosphate ester. The electrolyte contains the water in an amount of 150 ppm or more and 30,000 ppm or less in terms of mass. The lithium salt includes at least one selected from a group consisting of lithium bis (trifluoromethanesulfonyl)imide (LiTFSI; LiN(SO₂CF₃)₂), lithium bis(fluorosulfonyl) imide (LiFSI; LiN(SO₂F)₂), lithium difluorooxalate borate (LiDFOB; LiBF₂(C₂O₄)), lithium bisoxalate borate (LiBOB; LiB[(OCO)₂])₂), and lithium triflate (LiOtF; LiCF₃SO₃, also known as: lithium trifluoromethane sulfonate).

The secondary battery may further include a separator provided between the positive electrode and the negative electrode. The negative electrode, the positive electrode, and the separator may configure an electrode group. The electrolyte may be held in the electrode group.

The secondary battery may further include a container member that houses the electrode group and the electrolyte.

The secondary battery may further include a negative electrode terminal electrically connected to the negative electrode and a positive electrode terminal electrically connected to the positive electrode.

The secondary battery may be, for example, a lithium secondary battery (lithium ion secondary battery). Although the secondary battery contains an electrolyte containing water, the battery differs from an aqueous electrolyte secondary battery containing an aqueous electrolyte (for example, aqueous electrolyte solution) with water being the main component of the electrolyte solvent. In the secondary battery, the water in the electrolyte is made minuscule, so as to achieve reductive decomposition suppression in the aqueous electrolyte secondary battery. The secondary battery cannot be considered a nonaqueous electrolyte secondary battery, either; although the water content is minuscule, the content of water in the electrolyte is great compared to a nonaqueous electrolyte battery containing a non-aqueous electrolyte, in which the content of water is generally 0.005 mass % (50 ppm) or less, and only 0.01 mass % (100 ppm) even at the maximum tolerable amount reported.

LiTFSI, LIFSI, LIDFOB, LiBOB, and LiOtF are lithium salts that are stable with respect to water and also to phosphate esters. With the electrolyte solution (electrolytic solution) containing a stable lithium salt and a phosphate ester together with a minuscule amount of water, the secondary battery can suppress side reactions such as reductive decomposition reaction at the negative electrode. By suppressing side reactions, high charge/discharge efficiency can be obtained.

The reason for which high charge/discharge efficiency can be obtained is presumed to be that a covering film suitable for suppressing side reactions between the negative electrode and the electrolyte is formed on the negative electrode by using an electrolyte containing the minuscule amount of water, the lithium salt, and the phosphate ester.

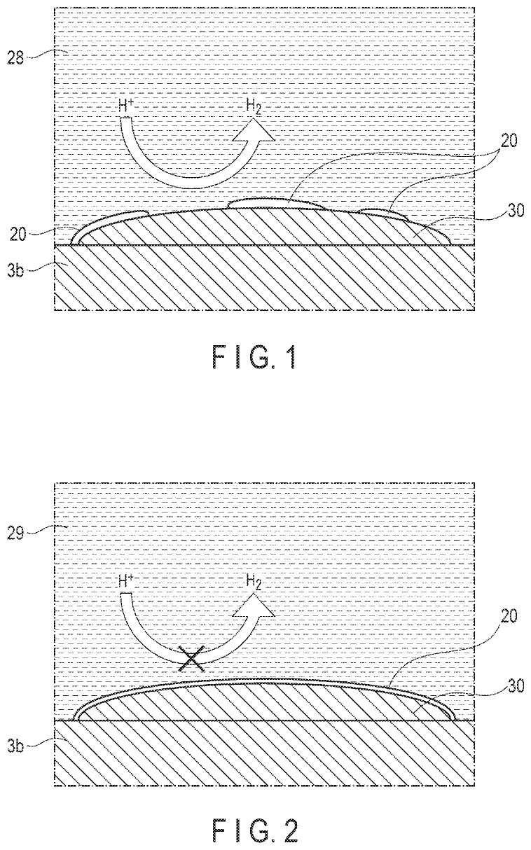

Suppression of side reactions between an electrode and an electrolytic solution by providing the covering film on the electrode has conventionally been in use. Also known as a measure for suppressing hydrogen generation due to a reductive decomposition reaction of water by a negative electrode in an aqueous electrolyte in which a lithium salt is dissolved in an aqueous solution, is increasing the concentration of the lithium salt to diminish water in the electrolytic solution. However, in the battery using such a conventional high-concentration aqueous electrolyte, as in the conceptual diagram shown in FIG. 1, the covering film 20 is sparsely formed on the negative electrode active material 30, and places where the negative electrode active material 30 is exposed to the aqueous electrolyte 28 are not insignificant. Therefore, water reacts even in a state where the concentration of the lithium salt of the aqueous electrolyte 28 is high, and the hydrogen generation suppressing effect would be insufficient. In FIG. 1 (and FIG. 2), the negative electrode active material 30 located on the surface of the negative electrode active material-containing layer 3b is schematically shown, and the illustration of the remaining portion of the negative electrode active material-containing layer 3b is omitted.

Unlike the conventional aqueous electrolyte battery, the secondary battery according to the embodiment contains a minuscule amount of water, a lithium salt, and a phosphate ester in the electrolyte. Such a secondary battery may contain, in the electrolyte, materials having properties of film-forming on the negative electrode. The minuscule amount of water contained in the electrolyte promotes covering film formation by the lithium salt and the covering film-forming material. As a result, there can be expected a formation of a covering film 20 that protects the negative electrode active material 30 from the electrolyte 29 as in the conceptual diagram shown in FIG. 2. With the negative electrode being protected by the covering film 20, an excellent hydrogen generation suppressing effect is exhibited, and the charge/discharge efficiency of the secondary battery is increased.

Hereinafter, the negative electrode, positive electrode, electrolyte, separator, container member, negative electrode terminal, and positive electrode terminal will be described in detail.

### (1) Negative Electrode

The negative electrode may include a negative electrode current collector and a negative electrode active material-containing layer. The negative electrode active material-containing layer may be formed on one surface or both of obverse and reverse surfaces of the negative electrode current collector. The negative electrode active material-containing layer may include a negative electrode active material, and optionally an electro-conductive agent and a binder.

The negative electrode may contain at least one element selected from the group consisting of F, P, B, N, and S on a surface thereof. For example, a covering film containing one or more of these elements may be formed on the surface of the negative electrode. As described later, the electrolyte may contain components that can be a source of these elements. Among the above elements, fluorine (F) and/or phosphorus (P) are more preferably included on the surface of the negative electrode.

The negative electrode active material-containing layer may include a carbon material, a silicon-containing compound or a metal oxide as the negative electrode active material. A material capable of insertion and extraction of Li ions is used as the negative electrode active material.

Examples of the carbon material for the negative electrode active material may include graphite substances such as graphite (e.g., artificial graphite or natural graphite), and carbon materials such as hard carbon, amorphous carbon and crystallized carbon. From the standpoint of increasing an energy density, it is desirable to use graphite as negative electrode active material.

Examples of the silicon-containing compound include silicon oxide SiOₓ (subscript x satisfies 0<x≤2). More specific examples include silicon monoxide (SiO) and silicon dioxide (SiO₂).

The metal oxide may include, for example, a titanium-containing oxide. As the titanium-containing oxide, an oxide of titanium, lithium titanium oxide, monoclinic niobium titanium oxide, orthorhombic titanium-containing composite oxide, and the like may be used. The negative electrode active material may contain one species or two or more species of titanium-containing oxides.

Examples of the oxide of titanium include titanium oxide having a monoclinic structure, titanium oxide having a rutile structure, and titanium oxide having an anatase structure. For the titanium oxide having each of the crystal structures, the composition before charge can be represented as TiO₂ and the composition after charge can be represented as LiₓTiO₂ (subscript x is 0≤x≤1). Further, for the titanium oxide having the monoclinic structure, the structure before charge can be represented as TiO₂ (B).

Examples of the lithium titanium oxide include a lithium titanium oxide having a spinel structure (e.g., a compound represented by Li₄₊ₓTi₅O₁₂ where −1≤x≤3), a lithium titanium oxide having a ramsdellite structure (e.g., a compound represented by Li₂₊ₓTi₃O₇ where −1≤x≤3, a compound represented by Li₁₊ₓTi₂O₄ where 0≤x≤1, a compound represented by Li_{1.1+x}Ti_{1.8}O₄ where 0≤x≤1, a compound represented by Li_{1.07+x}Ti_{1.86}O₄ where 0≤x≤1, and a compound represented by LiₓTiO₂ where 0<x≤1), and the like. The lithium titanium oxide may be a lithium-titanium composite oxide having a dopant introduced therein.

Examples of the monoclinic niobium titanium oxide include a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. The respective subscripts in the composition formula are specified as follows: 0≤x≤5, 0≤y<1, 0≤z<2, and −0.3≤δ≤0.3. Specific examples of the monoclinic niobium titanium oxide include LiₓNb₂TiO₇ (0≤x≤5).

Another example of the monoclinic niobium titanium oxide is a compound represented by LiₓTi_{1-y}M3_{y+z}Nb_{2-z}O_{7-δ}. Here, M3 is at least one selected from the group consisting of Mg, Fe, Ni, Co, W, Ta, and Mo. The respective subscripts in the composition formula are specified as follows: 0≤x≤5, 0≤y<1, 0≤z<2, and −0.3≤δ≤0.3.

Still other examples of the monoclinic niobium titanium oxide include, for example, Nb₂TiO₇, Nb₂Ti₂O₉, Nb₁₀Ti₂O₂₉, Nb₁₄TiO₃₇, and Nb₂₄TiO₆₂. The monoclinic niobium titanium oxide may be a substituted niobium titanium oxide, in which at least a part of Nb and/or Ti is substituted with a dopant. Examples of the substituent element include Na, K, Ca, Co, Ni, Si, P, V, Cr, Mo, Ta, Zr, Mn, Fe, Mg, B, Pb, Al, etc. The substituted niobium titanium oxide may include one species of substituent element, or may include two or more species of substituent element.

Examples of the orthorhombic titanium-containing composite oxide include a compound represented by Li₂₊ₐM^{I}_{2-b}Ti_{6-c}M^{II}_{d}O_{14+c}. Here, M^{I} is at least one selected from the group consisting of Sr, Ba, Ca, Mg, Na, Cs, Rb and K. M^{II} is at least one selected from the group consisting of Zr, Sn, V, Nb, Ta, Mo, W, Y, Fe, Co, Cr, Mn, Ni and Al. The respective subscripts in the composition formula are specified as follows: 0≤a≤6, 0≤b<2, 0≤c<6, 0≤d<6, and −0.5≤σ≤0.5. Specific examples of the orthorhombic titanium-containing composite oxide include Li₂₊ₐNa₂Ti₆O₁₄ (0≤a≤6).

The negative electrode active material is contained in the negative electrode active material-containing layer, for example, in the form of particles. Negative electrode active material particles may be single primary particles, secondary particles which are agglomerates of the primary particles, or a mixture of single primary particles and secondary particles. The shape of the particles is not particularly limited, and may be, for example, a spherical shape, an elliptical shape, a flat shape, a fibrous shape, or the like.

The electro-conductive agent is added to increase the current-collecting performance and suppress the contact resistance between the active material and the current collector. Examples of the electro-conductive agent include carbonaceous materials such as vapor grown carbon fiber (VGCF), carbon black such as acetylene black, and graphite. Other than that, fibrous carbon materials like carbon nanotubes and carbon nanofibers may be used as the electro-conductive agent. One of these may be used as the electro-conductive agent, or alternatively, two or more may be combined and used as the electro-conductive agent. Alternatively, instead of using the electro-conductive agent, surfaces of the active material particles may be subjected to carbon coating or electron conductive inorganic material coating. The electro-conductive agent may be omitted. For example, the electro-conductive agent may be omitted when using the carbon material as the negative electrode active material.

The binder is added to fill gaps between dispersed active materials and to bind the active material and the negative electrode current collector. Examples of the binder include polytetrafluoroethylene (PTFE), polyvinylidene fluoride (PVdF), fluororubber, styrene butadiene rubber, polyacrylate compounds, imide compounds, carboxymethyl cellulose (CMC), and salts of CMC. One of these may be used as the binder, or alternatively, two or more may be combined and used as the binder.

In the negative electrode active material-containing layer using the carbon material as negative electrode active material, the negative electrode active material and binder are preferably blended in proportions of 70% by mass to 98.5% by mass and 1.5% by mass to 30% by mass, respectively. When the amount of binder is 1.5% by mass or more, binding between the active material-containing layer and current collector is sufficient, and excellent cycling performance can be expected. On the other hand, an amount of binder is preferably 30% by mass or less, in view of increasing the capacity.

In the negative electrode active material-containing layer using the titanium-containing oxide or silicon-containing compound as negative electrode active material, the blending portions of the negative electrode active material, electro-conductive agent, and binder in the negative electrode active material-containing layer are preferably 70% by mass to 95% by mass of negative electrode active material, 3% by mass to 20% by mass of electro-conductive agent, and 2% by mass to 10% by mass of binder. When the blending ratio of the electro-conductive agent is 3% by mass or more, current-collecting performance of the negative electrode active material-containing layer can be improved. When the content of the binder is 2% by mass or more, sufficient electrode strength can be obtained. The binder may serve as an insulator. Therefore, when the content of the binder is 10% by mass or less, insulating section within the electrode can be reduced.

There may be used for the negative electrode current collector, a material which is electrochemically stable at the potential at which lithium (Li) is inserted into and extracted from the negative electrode active material. For example, when the carbon material is used as negative electrode active material, a foil made of copper, nickel, titanium, zinc or stainless steel can be used for the current collector. When the above titanium-containing oxide is used as negative electrode active material, preferably used for the current collector is a foil made of copper, nickel, titanium, zinc, stainless steel, aluminum, or an aluminum alloy including one or more selected from the group consisting of Mg, Ti, Zn, Mn, Fe, Cu, and Si. The form of the negative electrode current collector may be, for example, a mesh or a porous body, besides a foil. To increase the energy density and improve the output, the shape of a foil having a small volume and a large surface area is desirable.

A thickness of the negative electrode current collector is preferably in the range of 5 μm to 20 μm. A current collector having such a thickness can maintain balance between the electrode strength and weight reduction.

In addition, the negative electrode current collector may include a portion on a surface thereof, where the negative electrode active material-containing layer is not disposed thereon. The portion can serve as a negative electrode current collecting tab. Alternatively, a negative electrode current collecting tab separate from the negative electrode current collector may be electrically connected to the negative electrode.

The density of the negative electrode active material-containing layer (excluding the current collector) is preferably in the range of 1.8 g/cm³ to 2.8 g/cm³. A negative electrode in which the density of the negative electrode active material-containing layer is within this range is excellent in energy density and retention of the electrolyte. The density of the negative electrode active material-containing layer is more preferably in the range of 2.1 g/cm³ to 2.6 g/cm³.

### (2) Positive Electrode

The positive electrode may include a positive electrode current collector and a positive electrode active material-containing layer. The positive electrode active material-containing layer may be provided on a principal surface on one side of the positive electrode current collector or on principal surfaces on both of obverse and reverse sides. The positive electrode active material-containing layer may include a positive electrode active material, and optionally an electro-conductive agent and a binder.

As the positive electrode active material, for example, an oxide or sulfide may be used. The positive electrode may contain one species of compound alone as the positive electrode active material, or alternatively may contain two or more species of compounds in combination. Examples of the oxide or sulfide include a compound capable of having an alkali metal or alkali metal ions be inserted and extracted.

Examples of such compounds include manganese dioxide (MnO₂), iron oxides, copper oxides, nickel oxides, lithium manganese composite oxides (e.g., LiₓMn₂O₄ or LiₓMnO₂; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}CO_{y}O₂; 0<x≤1, 0<y<1), lithium manganese cobalt composite oxides (e.g., LiₓMn_{y}Co_{1-y}O₂; 0<x≤1, 0<y<1), lithium manganese nickel composite oxides having a spinel structure (e.g., LiₓMn_{2-y}Ni_{y}O₄; 0<x≤1, 0<y<2), lithium phosphates having an olivine structure (e.g., LiₓFePO₄; 0<x≤1, LiₓFe_{1-y}Mn_{y}PO₄; 0<x≤1, 0<y<1, and LiₓCoPO₄; 0<x≤1), iron sulfate (Fe₂(SO₄)₃), vanadium oxides (e.g., V₂O₅), and lithium nickel cobalt manganese composite oxides (LiₓNi_{1-y-z}CO_{y}MnₓO₂; 0<x≤1, 0<y≤1, 0<z<1, y+z<1).

Among the above compounds, examples of compounds more preferable as the positive electrode active material include lithium manganese composite oxides having a spinel structure (e.g., LiₓMn₂O₄; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}CO_{z}O₂; 0<x≤1, 0<y<1), lithium manganese nickel composite oxides having a spinel structure (e.g., LiₓMn_{2-y}Ni_{y}O₄; 0<x≤1, 0<y<2), lithium manganese cobalt composite oxides (e.g., LiₓMn_{y}CO_{1-y}O₂; 0<x≤1, 0<y<1), lithium iron phosphates (e.g., LiₓFePO₄; 0<x≤1), and lithium nickel cobalt manganese composite oxides (LiₓNi_{1-y-z}CO_{y}Mn_{z}O₂; 0<x≤1, 0<y<1, 0<z<1, y+z<1). When these compounds are used as the positive electrode active material, the positive electrode potential can be increased.

The primary particle size of the positive electrode active material is preferably from 100 nm to 1 μm. The positive electrode active material having a primary particle size of 100 nm or more is easy to handle during industrial production. In the positive electrode active material having a primary particle size of 1 μm or less, in-solid diffusion of lithium ions can proceed smoothly.

The specific surface area of the positive electrode active material is preferably in the range of 0.1 m²/g to 10 m²/g. A positive electrode active material having the specific surface area of 0.1 m²/g or more can adequately secure insertion/extraction sites of Li ions. A positive electrode active material having the specific surface area of 10 m²/g or less is easy to handle in industrial production and also can ensure charge-and-discharge cycle performance.

The binder is added to fill gaps among the dispersed positive electrode active material and also to bind the positive electrode active material with the positive electrode current collector. Examples of the binder include polytetrafluoroethylene (PTFE), polyvinylidene fluoride (PVdF), fluororubber, polyacrylate compounds, imide compounds, carboxymethyl cellulose (CMC), and salts of CMC. One of these may be used as the binder, or alternatively, two or more may be used in combination as the binder.

The electro-conductive agent is added to improve current collecting performance and to suppress the contact resistance between the positive electrode active material and the positive electrode current collector. Examples of the electro-conductive agent include carbonaceous substances such as vapor grown carbon fiber (VGCF), carbon black such as acetylene black, and graphite. One of these may be used as the electro-conductive agent, or alternatively, two or more may be used in combination as the electro-conductive agent. The electro-conductive agent may be omitted, as well.

In the positive electrode active material-containing layer, the positive electrode active material and binder are preferably blended in proportions of 80% by mass to 98% by mass, and 2% by mass to 20% by mass, respectively.

By setting the amount of the binder to 2% by mass or more, sufficient electrode strength can be obtained. The binder may also function as an electrical insulator. Thus, if the amount of the binder is set to 20% by mass or less, the amount of electrical insulator contained in the electrode decreases, and thereby internal resistance can be decreased.

When an electro-conductive agent is added, the positive electrode active material, the binder, and the electro-conductive agent are preferably blended in proportions of 77% by mass to 95% by mass, 2% by mass to 20% by mass, and 3% by mass to 15% by mass, respectively.

By setting the amount of the electro-conductive agent to 3% by mass or more, the above-mentioned effects can be expressed. By setting the amount of the electro-conductive agent to 15% by mass or less, the proportion of the electro-conductive agent in contact with the electrolyte can be reduced. When this proportion is low, decomposition of the electrolyte can be reduced during storage under high temperatures.

The positive electrode current collector is preferably a metal foil of titanium, aluminum, stainless steel and the like, or an alloy foil of aluminum alloy containing one or more selected from the group consisting of Mg, Ti, Zn, Ni, Cr, Mn, Fe, Cu, and Si. The current collector surface may be covered with a different element in order to prevent corrosion of the current collector due to reactions between the current collector and the electrolyte.

A thickness of the positive electrode current collector is preferably 5 μm to 20 μm, and more preferably 15 μm or less.

In addition, the positive electrode current collector may include a portion on a surface thereof where the positive electrode active material-containing layer is not disposed thereon. The portion can serve as a positive electrode current collecting tab. Alternatively, a positive electrode current collecting tab separate from the positive electrode current collector may be electrically connected to the positive electrode.

### (3) Electrolyte

The secondary battery according to the embodiment includes an electrolyte. The electrolyte may be at least partially held in the electrode group. The electrolyte at least contains water, at least one lithium salt selected from the group consisting of LiTFSI, LiFSI, LiDFOB, LiBOB, and LiOtF, and a phosphate ester. The content of water contained in the electrolyte is 150 ppm or more and 30,000 ppm or less in mass units. The content of water is preferably within a range of 200 ppm or more and 3000 ppm or less, and more preferably within a range of 200 ppm or more and 300 ppm or less in terms of units in mass.

The electrolyte may be, for example, a liquid electrolyte. The liquid electrolyte is prepared by dissolving an electrolyte salt as a solute in a solvent. The concentration of the electrolyte salt is preferably 0.5 mol/L or more and 2.5 mol/L or less. The electrolyte salt includes a lithium salt.

LiTFSI, LiFSI, LiDFOB, LiBOB, and LiOtF are lithium salts stable with respect to water and phosphate esters. Among them, a salt containing fluorine, which excludes LiBOB, serves as an F source of fluorine that may be contained in the covering film formed on the negative electrode surface. LiDFOB and LiBOB contain boron, and serve as a B source of boron that may be contained in the covering film. LiTFSI, LiFSI, and LiOtF contain sulfur, and serve as an S source of sulfur that can be contained in the covering film.

Referring to the LiTFSI, LiFSI, LIDFOB, LiBOB, and LiOtF as a first lithium salt, the electrolyte may further include a second lithium salt different therefrom. Examples of the second lithium salt include lithium chloride (LiCl), lithium bromide (LiBr), lithium hydroxide (LiOH), lithium sulfate (Li₂SO₄), lithium nitrate (LiNO₃), lithium acetate (CH₃COOLi), lithium oxalate (Li₂C₂O₄), lithium carbonate (Li₂CO₃), lithium perchlorate (LiClO₄), lithium hexafluorophosphate (LiPF₆), lithium tetrafluoroborate (LiBF₄), and lithium hexafluoroarsenate (LiAsF₆).

The water and the phosphate ester serve as a solvent of the electrolyte. The phosphate ester is an organic solvent but exhibits non-flammability. Therefore, by containing a phosphate ester as a solvent, a non-combustible electrolyte can be obtained. In addition, by containing a phosphate ester, the covering film containing a phosphate salt may be formed on the negative electrode. That is, the phosphate ester serves as a P source of phosphorus that may be contained in the covering film formed on the surface of the negative electrode. Examples of the phosphate ester include trimethyl phosphate, triethyl phosphate, tripropyl phosphate, and tributyl phosphate. In addition, a fluorine-substituted phosphate ester in which at least one of hydrogen atoms of the phosphate ester is substituted with a fluorine atom can be mentioned as another example. Such an electrolyte may contain at least one selected from the group consisting of these phosphate esters and fluorine-substituted phosphate esters. The amount of the phosphate ester in the electrolyte is preferably 30 mass or more and 70 mass % or less.

The electrolyte may also include a solvent other than water and the phosphate ester. For example, an organic solvent other than the phosphate ester may be contained in the electrolyte. Examples of other organic solvents include cyclic carbonates such as propylene carbonate (PC), ethylene carbonate (EC), fluoroethylene carbonate (FEC), vinylene carbonate (VC); linear carbonates such as diethyl carbonate (DEC), dimethyl carbonate (DMC), methyl ethyl carbonate (MEC); cyclic ethers such as tetrahydrofuran (THF), 2-methyl tetrahydrofuran (2MeTHF), dioxolane (DOX); linear ethers such as dimethoxy ethane (DME) and diethoxy ethane (DEE); γ-butyrolactone (GBL), acetonitrile (AN), and sulfolane (SL). Fluoroethylene carbonate can serve as a fluorine source of F that may be contained in the negative electrode surface. Sulfolane can serve as a sulfur source of S that may be contained in the negative electrode surface.

The electrolyte may further contain at least one selected from the group consisting of a nitrile compound such as succinonitrile, an isocyanate compound, a compound having an amide group, a carbonate ester, and a fluorinated carbonate ester. The nitrile compound and the compound having an amide group can serve as a nitrogen source of N that may be contained in the surface of the negative electrode. The isocyanate compound can serve as a sulfur source of S that may be contained in the negative electrode surface. The fluorinated carbonate ester can serve as a fluorine source of F that may be contained in the negative electrode surface.

The electrolyte may be a gel electrolyte. The gel electrolyte is prepared by mixing the above-described liquid electrolyte and a polymer compound to obtain a composite. Examples of the polymer compound include polyvinylidene fluoride (PVdF), polyacrylonitrile (PAN), and polyethylene oxide (PEO).

### (4) Separator

The separator may be, for example, disposed between the negative electrode and the positive electrode. The separator prevents electrical contact between the negative electrode and the positive electrode.

As the separator, one having a shape capable of having migration of the electrolyte within the separator.

The separator may have a porous structure. Porous separators include, for examples, a non-woven fabric, a film, a paper sheet, and the like. Examples of the material forming the porous separator may include polyolefin such as polyethylene and polypropylene, and cellulose. Preferable examples of the porous separator include a non-woven fabric including cellulose fiber, a porous film including a polyolefin fiber, and the like.

In view of safety, a porous film made of polyethylene or polypropylene is preferred. This is because at a certain temperature, such a porous film melts and can thereby shut off current.

The porous separator preferably has a porosity of 60% or more. The fiber diameter is preferably 10 μm or less in a separator including fibers. When the fiber diameter is 10 μm or less, the affinity of the porous separator with the electrolyte is improved, thus resulting in decreased battery resistance. The more preferable range of the fiber diameter is 3 μm or less. The cellulose-including non-woven fabric having a porosity of 60% or more can be well impregnated with the electrolyte. Therefore, by using such a nonwoven fabric, a high output performance can be exhibited spanning from a low temperature to a high temperature. A more preferable range of the porosity is from 62% to 80%.

A separation layer described below may be used as the separator. Such a separation layer and the above porous separator may be used together as the separator. For example, a composite obtained by forming the separation layer on one surface or both of obverse and reverse surfaces of a porous film may be used as the separator.

As the separation layer, there may be used a membrane containing inorganic solid particles and a polymer material, for example, a composite membrane of inorganic solid particles and a polymer material, or an ion exchange membrane. The inorganic solid particles may be, for example, solid electrolyte particles, and the membrane may be a solid electrolyte membrane. The solid electrolyte membrane may be, for example, a solid electrolyte composite membrane formed using solid electrolyte particles and a polymer material, and casting them into film form.

Examples of the inorganic solid particles that can be contained in the separation layer include: oxide ceramics such as alumina, silica, zirconia, yttria, magnesium oxide, calcium oxide, barium oxide, strontium oxide, and vanadium oxide; carbonates and sulfates such as sodium carbonate, potassium carbonate, magnesium carbonate, calcium carbonate, barium carbonate, lanthanum carbonate, cerium carbonate, calcium sulfate, magnesium sulfate, aluminum sulfate, gypsum, and barium sulfate; phosphates such as hydroxyapatite, lithium phosphate, zirconium phosphate, and titanium phosphate; and nitride ceramics such as silicon nitride, titanium nitride, and boron nitride. The inorganic particles described above may be in the form of a hydrate.

The inorganic solid particles preferably include solid electrolyte particles having ion conductivity of lithium ions. Specifically, inorganic solid particles having ion conductivity with respect to lithium ions are more preferable. The expression “having lithium ion conductivity” as used herein refers to exhibiting lithium ion conductivity of 1×10⁻⁶ S/cm or more at 25° C. The lithium ion conductivity can be measured by, for example, an alternating-current impedance method. By using such inorganic solid particles, a separation layer having lithium ion conductivity can be obtained.

Examples of the inorganic solid particles having lithium ion conductivity include oxide solid electrolytes and sulfide solid electrolytes. As the oxide solid electrolyte, a lithium phosphate solid electrolyte having a NASICON (Sodium (Na) Super Ionic Conductor) structure and represented by the general formula Li₁₊ₓMα₂(PO₄)₃ is preferably used. Mα in the above general formula is, for example, one or more selected from the group consisting of titanium (Ti), germanium (Ge), strontium (Sr), zirconium (Zr), tin (Sn), aluminum (Al), and calcium (Ca). The subscript x is within a range of 0≤x≤2.

Specific examples of the lithium phosphate solid electrolyte having the NASICON structure include: a LATP compound represented by Li₁₊ₓAlₓTi₂₋ₓ (PO₄)₃, where 0.1≤x≤0.5; a compound represented by Li₁₊ₓAl_{y}Mβ_{2-y} (PO₄)₃, where MB is one or more selected from the group consisting of Ti, Ge, Sr, Zr, Sn and Ca, 0≤x≤1 and 0≤y≤1; a compound represented by Li₁₊ₓAlₓGe₂₋ₓ (PO₄)₃, where 0≤x≤2; a compound represented by Li₁₊ₓAlₓZr₂₋ₓ (PO₄)₃, where 0≤x≤2; a compound represented by Li_{1+x+y}AlₓMγ₂₋ₓSi_{y}P_{3-y}O₁₂, where My is one or more selected from the group consisting of Ti and Ge, 0<x≤2, and 0≤y<3; and a compound represented by Li₁₊₂ₓZr₁₋ₓCaₓ (PO₄)₃, where 0≤x<1. Li₁₊₂ₓZr₁₋ₓCaₓ (PO₄)₃ has high water resistance, low reducibility, and low cost, and hence is preferably used as inorganic solid electrolyte particles.

In addition to the lithium phosphate solid electrolyte, examples of the oxide solid electrolyte include: an amorphous LIPON compound represented by LiₓPO_{y}N_{z}, where 2.6≤x≤3.5, 1.9≤y≤3.8, and 0.1≤z≤1.3 (e.g., Li_{2.9}PO_{3.3}N_{0.46}); a compound represented by La₅₊ₓAₓLa₃₋ₓMδ₂O₁₂ having a garnet structure, where A is one or more selected from the group consisting of Ca, Sr and Ba, Mδ is one or more selected from the group consisting of Nb and Ta, and 0≤x≤0.5; a compound represented by Li₃Mδ₂₋ₓL₂O₁₂, where Mδ is one or more selected from the group consisting of Nb and Ta, L may contain Zr, and 0≤x≤0.5; a compound represented by Li₇₋₃ₓAlₓLa₃Zr₃O₁₂, where 0≤x≤0.5; a LLZ compound represented by Li₅₊ₓLa₃Mδ₂₋ₓZrₓO₁₂, where Mo is one or more selected from the group consisting of Nb and Ta, and 0≤x≤2 (e.g., Li₇La₃Zr₂O₁₂); and a compound having a perovskite structure and represented by La_{2/3-x}LiₓTiO₃, where 0.3≤x≤0.7. The solid electrolyte may be used singly or in combination of two or more species thereof.

In the separation layer, a single species of inorganic solid particles may be used, or multiple species thereof may be mixed and used.

The polymer material contained in the separation layer enhances the binding property between the inorganic solid particles. Examples of the polymer material include one or more selected from the group consisting of polyvinyl formal, polyvinyl alcohol, polyvinyl acetal, polyvinyl butyral, polymethyl methacrylate, polyethylene terephthalate, polypropylene, polyethylene, polyvinylidene fluoride, and polytetrafluoroethylene.

As the polymer material contained in the separation layer, a single species of polymer may be used, or multiple species may be mixed and used.

The separation layer may contain a plasticizer or an electrolyte salt in addition to the inorganic solid particles and the polymer material. For example, in a case where the separation layer contains an electrolyte salt, the lithium ion conductivity in the separation layer can be further enhanced.

### (5) Container Member

As the container member that houses the negative electrode, positive electrode, separator and electrolyte, a metal container, a laminated film container or a resin container may be used.

As the metal container, a metal can made of nickel, iron, stainless steel, or the like and having a prismatic shape or a cylindrical shape may be used. As the resin container, a container made of polyethylene, polypropylene, or the like may be used.

The plate thickness of each of the resin container and the metal container preferably falls within the range of 0.05 mm to 1 mm. The plate thickness is more preferably 0.5 mm or less, and even more preferably 0.3 mm or less.

As the laminated film, for example, a multilayered film formed by covering a metal layer with resin layers may be used. Examples of the metal layer include a stainless steel foil, an aluminum foil, and an aluminum alloy foil. As the resin layer, a polymer such as polypropylene (PP), polyethylene (PE), nylon, or polyethylene terephthalate (PET) may be used. The thickness of the laminated film preferably falls within the range of 0.01 mm to 0.5 mm. The thickness of the laminated film is more preferably 0.2 mm or less.

### (6) Negative Electrode Terminal

The negative electrode terminal may be formed, for example, from a material that is electrochemically stable at the potential of lithium ion insertion-extraction for the negative electrode active material and having electrical conductivity. Specifically, the material for the negative electrode terminal may include copper, nickel, titanium, zinc, stainless steel, aluminum, or an aluminum alloy containing at least one element selected from the group consisting of Mg, Ti, Zn, Mn, Fe, Cu, and Si. In order to reduce the contact resistance between the negative electrode terminal and the negative electrode current collector, the negative electrode terminal is preferably made of the same material as that of the negative electrode current collector.

### (7) Positive Electrode Terminal

The positive electrode terminal may be made, for example, from a material that is electrically stable in a potential range of 3 V to 4.5 V with respect to oxidation-reduction potential of lithium (vs. Li/Li⁺) and having electrical conductivity. Examples of the material for the positive electrode terminal include titanium, aluminum, or an aluminum alloy containing at least one element selected from the group consisting of Mg, Ti, Zn, Mn, Fe, Cu, and Si. In order to reduce the contact resistance between the positive electrode terminal and the positive electrode current collector, the positive electrode terminal is preferably made of the same material as that of the positive electrode current collector.

The secondary battery according to the embodiment may be used in various forms such as a prismatic shape, a cylindrical shape, a flat form, a thin form, and a coin form. In addition, the secondary battery may be a secondary battery having a bipolar structure. A secondary battery having a bipolar structure has an advantage of being able to produce a cell with in-series connection of multiple, using a single cell.

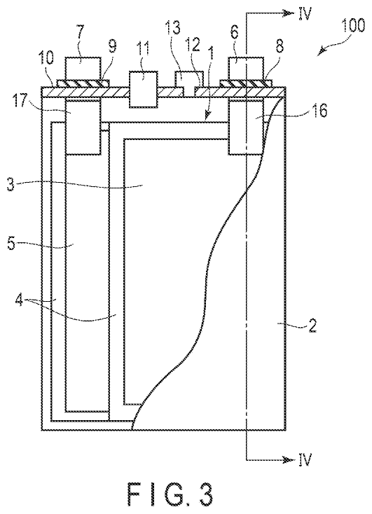

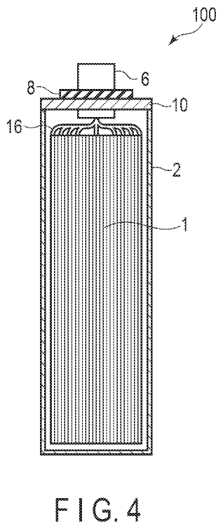

Details of the secondary battery according to the embodiment will be described below with reference to FIGS. 3 and 4. FIG. 3 is a sectional view schematically showing an example of the secondary battery according to the embodiment. FIG. 4 is a sectional view of the secondary battery shown in FIG. 3 taken along a line IV-IV.

An electrode group 1 is housed in a container member 2 made of a rectangular tubular metal container. The electrode group 1 includes a negative electrode 3, a separator 4, and a positive electrode 5. The electrode group 1 has a structure formed by interposing the separator 4 between the positive electrode 5 and the negative electrode 3 and spirally winding so as to form a flat shape. An electrolyte (not shown) is held by the electrode group 1. As shown in FIG. 3, a strip-shaped negative electrode lead 16 is electrically connected to each of plural portions at an end of the negative electrode 3 located on an end face of the electrode group 1. In addition, a strip-shaped positive electrode lead 17 is electrically connected to each of plural portions at an end of the positive electrode 5 located on the end face. The plural negative electrode leads 16 are electrically connected to a negative electrode terminal 6 in a bundled state, as shown in FIG. 4. In addition, the plural positive electrode leads 17 are similarly electrically connected to a positive electrode terminal 7 in a bundled state, although not shown.

A sealing plate 10 made of metal is fixed to the opening portion of the container member 2 made of metal by welding or the like. The negative electrode terminal 6 and the positive electrode terminal 7 are extracted to the outside from outlets provided in the sealing plate 10. On the inner surfaces of the outlets of the sealing plate 10, a negative electrode gasket 8 and a positive electrode gasket 9 are arranged to avoid a short circuit caused by contact respective with the negative electrode terminal 6 and the positive electrode terminal 7. By providing the negative electrode gasket 8 and the positive electrode gasket 9, the airtightness of the secondary battery 100 can be maintained.

A control valve 11 (safety valve) is provided on the sealing plate 10. When the internal pressure of the battery cell is raised due to gas generation, for example, the generated gas can be released from the control valve 11 to the outside. As the control valve 11 there may be used, for example, a return type valve that operates when the internal pressure exceeds a predetermined value and functions as a sealing plug when the internal pressure lowers. Alternatively, there may be used a non-return type valve that cannot recover the function as a sealing plug once it operates. In FIG. 3, the control valve 11 is disposed in the middle of the sealing plate 10. However, the position of the control valve 11 may be an end of the sealing plate 10. The control valve 11 may be omitted.

Additionally, an inlet 12 is provided on the sealing plate 10. The electrolyte may be put in via the inlet 12. The inlet 12 may be closed with a sealing plug 13 after the electrolyte is put in. The inlet 12 and the sealing plug 13 may be omitted.

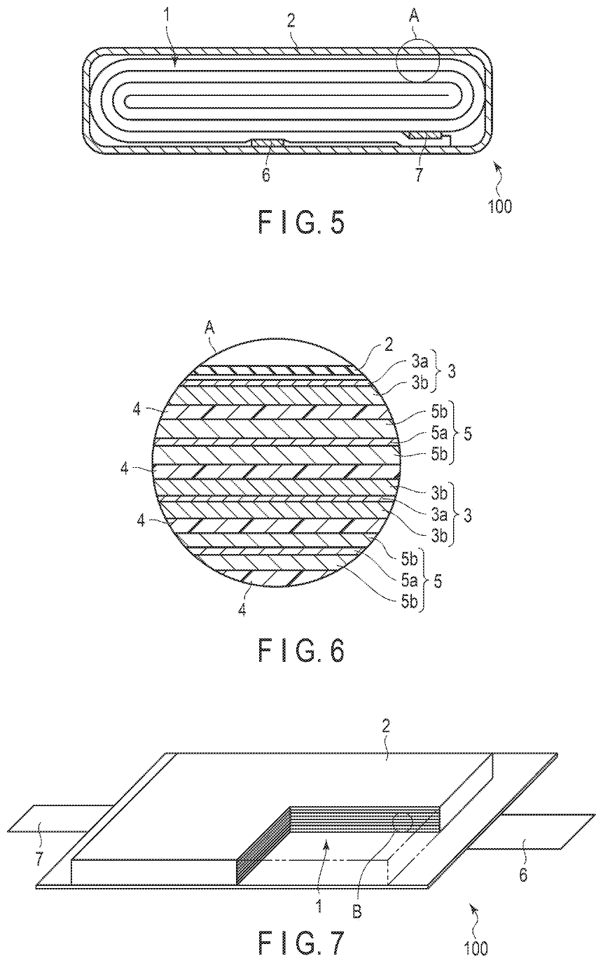

Another example of the secondary battery is exemplified. FIG. 5 is a cross-sectional view schematically showing another example of the secondary battery. FIG. 6 is an enlarged cross-sectional view of section A of the secondary battery shown in FIG. 5.

The secondary battery 100 shown in FIGS. 5 and 6 includes a bag-shaped container member 2, an electrode group 1, and an electrolyte, which is not shown. The electrode group 1 and the electrolyte are housed in the container member 2. The electrolyte (not shown) is held in the electrode group 1.

The container member 2 is made of a laminate film including two resin layers and a metal layer sandwiched between the resin layers.

As shown in FIG. 5, the electrode group 1 is a wound electrode group in a flat form. The wound electrode group 1 in a flat form includes a negative electrode 3, a separator 4, and a positive electrode 5, as shown in FIG. 6. The separator 4 is sandwiched between the negative electrode 3 and the positive electrode 5.

The negative electrode 3 includes a negative electrode current collector 3a and a negative electrode active material-containing layer 3b. At the portion of the negative electrode 3 positioned outermost among the wound electrode group 1, the negative electrode active material-containing layer 3b is formed only on an inner surface of the negative electrode current collector 3a, as shown in FIG. 6. For the other portions of the negative electrode 3, negative electrode active material-containing layers 3b are formed on both of obverse and reverse surfaces of the negative electrode current collector 3a.

The positive electrode 5 includes a positive electrode current collector 5a and positive electrode active material-containing layers 5b formed on both of obverse and reverse surfaces of the positive electrode current collector 5a.

As shown in FIG. 5, a negative electrode terminal 6 and positive electrode terminal 7 are positioned in vicinity of the outer peripheral edge of the wound electrode group 1. The negative electrode terminal 6 is connected to a portion of the negative electrode current collector 3a positioned outermost. The positive electrode terminal 7 is connected to a portion of the positive electrode current collector 5a positioned outermost. The negative electrode terminal 6 and the positive electrode terminal 7 extend out from an opening of the container member 2. A thermoplastic resin layer is provided on the inner surface of the container member 2, and the opening is sealed by heat-sealing the resin layer.

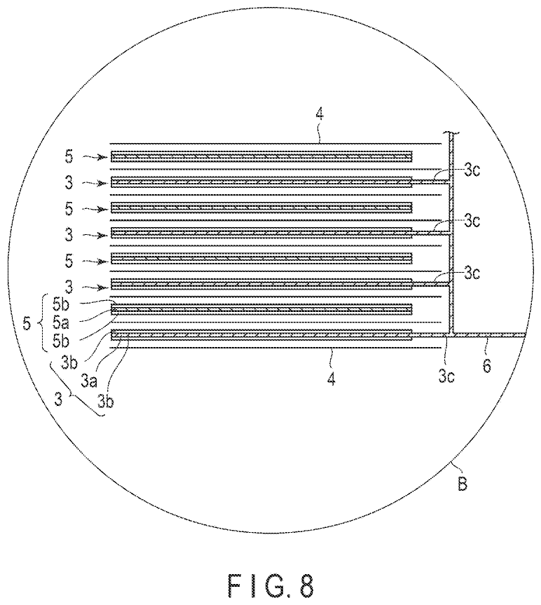

FIG. 7 is a partially cut out perspective view schematically showing yet another example of the secondary battery according to the embodiment. FIG. 8 is an enlarged sectional view of section B of the secondary battery shown in FIG. 7. FIG. 7 and FIG. 8 show an example of the secondary battery 100 using a laminated film container member as a container member.

The secondary battery 100 shown in FIGS. 7 and 8 includes an electrode group 1 shown in FIGS. 7 and 8, a container member 2 shown in FIG. 7, and an electrolyte, which is not shown. The electrode group 1 and the electrolyte are housed in the container member 2. The electrolyte is held in the electrode group 1.

The container member 2 is made of a laminated film including two resin layers and a metal layer sandwiched between the resin layers.

As shown in FIG. 8, the electrode group 1 is a stacked electrode group. The stacked electrode group 1 has a structure in which negative electrodes 3 and positive electrodes 5 are alternately stacked.

The electrode group 1 includes plural negative electrodes 3. Each of the plural negative electrode 3 includes a negative electrode current collector 3a and negative electrode active material-containing layers 3b arranged on both surfaces of the negative electrode current collector 3a. The electrode group 1 further includes plural positive electrodes 5. Each of the positive electrodes 5 includes a positive electrode current collector 5a and positive electrode active material-containing layers 5b supported on both surfaces of the positive electrode current collector 5a.

The negative electrode current collector 3a of each of the negative electrodes 3 includes at one end, a portion where the negative electrode active material-containing layer 3b is not supported on any surface. The portion serves as a negative electrode current collecting tab 3c. As shown in FIG. 8, the negative electrode current collecting tab 3c does not overlap the positive electrode 5. Plural negative electrode current collecting tabs 3c are electrically connected to a belt-shaped negative electrode terminal 6. A leading end of the belt-shaped negative electrode terminal 6 is drawn to the outside from the container member 2.

Although not shown, the positive electrode current collector 5a of each of the positive electrodes 5 includes at one end a portion where the positive electrode active material-containing layer 5b is not supported on any surface. This portion serves as a positive electrode current collecting tab. Like the negative electrode current collecting tab 3c, the positive electrode current collecting tab does not overlap the negative electrode 3. Further, the positive electrode current collecting tab is located on the opposite side of the electrode group 1 with respect to the negative electrode current collecting tab 3c. The positive electrode current collecting tabs are electrically connected to a belt-shaped positive electrode terminal 7. A leading end of the belt-shaped positive electrode terminal 7 is located on the opposite side of the negative electrode terminal 6 and drawn to the outside from the container member 2.

### <Measurement Methods>

A method for examining the negative electrode surface, the negative electrode active material, the positive electrode active material, and the electrolyte will be described below.

In a case where the negative electrode and the positive electrode are contained in a battery, the battery is disassembled to take out the negative electrode and the positive electrode, and the negative electrode and the positive electrode are washed with dimethyl carbonate (DMC). The washing method will be described below. The electrode (negative electrode or positive electrode) is immersed in DMC for 5 minutes, and the electrode is taken out. This is repeated three times, and after the electrode is dried, the electrode is subjected to measurement. Upon repeating the immersion, a new liquid of DMC is used each time.

In a case where the electrolyte is taken out from the battery, the battery is disassembled, and if the liquid electrolyte (electrolytic solution) is contained outside the electrode, the electrolyte not impregnated in the electrode is collected. In a case where the electrolyte cannot be collected from outside the electrode, the electrode group is placed in a centrifuge, and the electrolyte is collected by centrifugation.

### (Measurement of Negative Electrode Surface)

Whether or not the surface of the negative electrode contains at least one element selected from the group consisting of F, P, B, N, and S can be confirmed by X-ray photoelectron spectroscopy (XPS) analysis under the conditions described below.

As the XPS apparatus, Quantera SXM manufactured by ULVAC-PHI, Inc. or an apparatus having a function equivalent thereto can be used. As an excitation X-ray source, a single-crystal spectroscopic Al-Kα ray (1486.6 eV) is used. The X-ray output is 4 KW (13 kV×310 mA), the photoelectron detection angle is 45°, and the analysis area is about 4 mm×0.2 mm. Scanning is performed at 0.10 eV/step.

### (Measurement of Negative Electrode Active Material)

The crystal structure and elemental composition of the negative electrode active material can be examined by powder X-ray diffraction (XRD) measurement and inductively coupled plasma (ICP) emission spectroscopy.

### (Measurement of Positive Electrode Active Material)

The crystal structure and elemental composition of the positive electrode active material can be examined by powder X-ray diffraction (XRD) measurement and inductively coupled plasma (ICP) emission spectroscopy.

### (Electrolyte)

That the electrolyte contains the phosphate ester and water can be examined by GC-MS (Gas Chromatography-Mass Spectrometry) measurement. Further, the salt concentration and the contents of phosphate ester and water in the electrolyte can be measured by, for example, ICP (Inductively Coupled Plasma) emission spectrometry. The molar concentration (mol/L) can be calculated by weighing out a specified amount of the electrolyte and calculating the concentration of contained salt. The number of moles of the solute and the solvent can be calculated by measuring the specific gravity of the electrolyte.

### <Production Method>

The secondary battery according to the embodiment can be produced as follows.

The method of producing the above secondary battery according includes preparing the negative electrode, preparing the positive electrode, preparing the electrolyte, preparing the container member, housing the negative electrode and the positive electrode in the container member, and putting in the electrolyte into the container member. The putting in the electrolyte is performed under an environment of a dew point of −20° C. or more and 0° C. or less.

The negative electrode and positive electrode may be respectively fabricated by, for example, the following method. First, an active material, electro-conductive agent, and binder are suspended in a solvent to prepare a slurry. The slurry is applied onto one face or both of obverse and reverse faces of a current collector. Next, the applied slurry is dried to obtain a stack of the active material-containing layer and the current collector. Then, the stack is pressed. In this manner, the respective electrode is fabricated. A negative electrode active material is used as the active material for fabricating the negative electrode, and a positive electrode active material is used as the active material for fabricating the positive electrode.

Alternatively, each electrode may be fabricated by the following method. First, the active material, electro-conductive agent, and binder are mixed to obtain a mixture thereof. Next, the mixture is molded into a pellet form. Next, an electrode can be obtained by arranging these pellets on the current collector.

The electrolyte can be prepared, for example, by dissolving a lithium salt in a solvent. The lithium salt contains at least the first lithium salt described above, and may further contain the second lithium salt. The solvent contains at least a minuscule amount (150 ppm by mass or more and 30,000 ppm by mass or less with respect to the entire electrolyte) of water and the phosphate ester.

Unlike the production of a nonaqueous electrolyte battery requiring a dry environment, exposure of the electrolyte to a somewhat wet environment having a dew point of −20° C. or more and 0° C. or less is tolerated. Therefore, since the dew point control does not need to be strictly performed, the cost and effort for manufacturing the battery can be saved.

The secondary battery according to the first embodiment includes the negative electrode, the positive electrode, and the electrolyte. The electrolyte contains the water, the lithium salt, and the phosphate ester. The electrolyte contains the water in an amount of 150 ppm or more and 30,000 ppm or less (mass ratio). The lithium salt includes at least one selected from the group consisting of lithium bis (trifluoromethanesulfonyl) imide, lithium bis (fluorosulfonyl) imide, lithium difluorooxalate borate, lithium bisoxalate borate, and lithium triflate. With the secondary battery, since the electrolysis of water is suppressed at the negative electrode, high charge-discharge efficiency is exhibited.

### Second Embodiment

According to a second embodiment, a battery module is provided. The battery module includes plural of secondary batteries according to the first embodiment.

In the battery module, each of the single-batteries may be arranged to be electrically connected in series or in parallel, or may be arranged in combination of in-series connection and in-parallel connection.

An example of the battery module according to the embodiment will be described next with reference to the drawings.

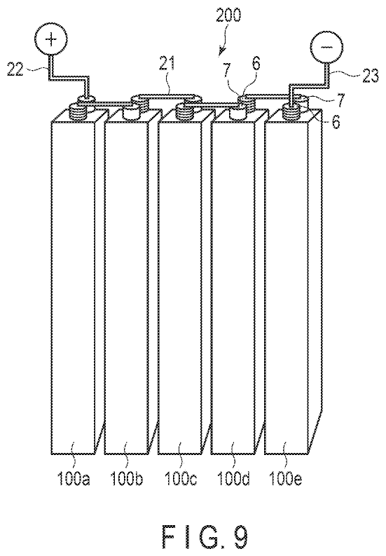

FIG. 9 is a perspective view schematically showing an example of the battery module. The battery module 200 shown in FIG. 9 includes five single-batteries 100a to 100e, four bus bars 21, a positive electrode-side lead 22, and a negative electrode-side lead 23. Each of the five single-batteries 100a to 100e is the secondary battery according to the first embodiment.

The bus bar 21 connects, for example, a negative electrode terminal 6 of one single-battery 100a and a positive electrode terminal 7 of the single-battery 100b positioned adjacent. In such a manner, five single-batteries 100 are thus connected in series by the four bus bars 21. That is, the battery module 200 shown in FIG. 9 is a battery module of five in-series connection. Although no example is depicted in drawing, in a battery module including plural single-batteries that are electrically connected in parallel, for example, the plural single-batteries may be electrically connected by having plural negative electrode terminals being connected to each other by bus bars while having plural positive electrode terminals being connected to each other by bus bars.

The positive electrode terminal 7 of at least one battery among the five single-batteries 100a to 100e is electrically connected to the positive electrode-side lead 22 for external connection. In addition, the negative electrode terminal 6 of at least one battery among the five single-batteries 100a to 100e is electrically connected to the negative electrode-side lead 23 for external connection.

The battery module according to the second embodiment includes the secondary battery according to the first embodiment. Therefore, the battery module can exhibit a high charge-discharge efficiency.

### Third Embodiment

According to a third embodiment, provided is a battery pack. The battery pack includes the battery module according to the second embodiment. The battery pack may include a single secondary battery according to the first embodiment, in place of the battery module according to the second embodiment.

The battery pack may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack may further include an external power distribution terminal. The external power distribution terminal is configured to externally output electric current from the secondary battery, and/or to input external electric current into the secondary battery. In other words, when the battery pack is used as a power source, electric current is provided out via the external power distribution terminal. When the battery pack is charged, the charging current (including regenerative energy of motive force of vehicles such as automobiles) is provided into the battery pack via the external power distribution terminal.

Next, an example of a battery pack according to the embodiment will be described with reference to the drawings.

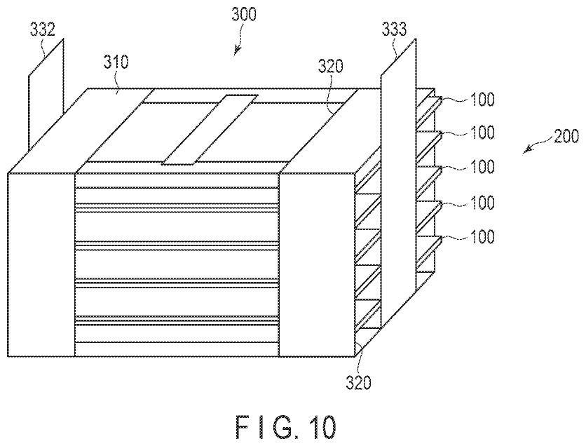

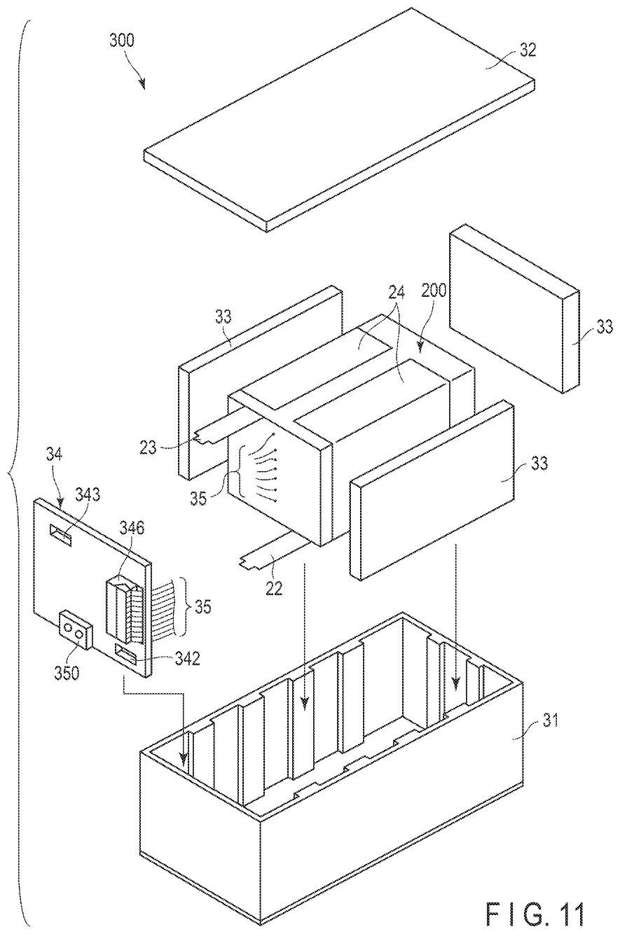

FIG. 10 is a perspective view schematically showing an example of the battery pack according to the embodiment.

A battery pack 300 includes a battery module configured of the secondary battery shown in FIGS. 7 and 8. The battery pack 300 includes a housing 310, and a battery module 200 housed in the housing 310. In the battery module 200, plural (for example, five) secondary batteries 100 are electrically connected in series. The secondary batteries 100 are stacked in a thickness direction. The housing 310 has an opening 320 on each of an upper portion and four side surfaces. The side surfaces, from which the positive and negative electrode terminals 6 and 7 of the secondary batteries 100 protrude, are exposed through the opening 320 of the housing 310. A positive electrode terminal 332 for output of the battery module 200 is belt-shaped, and one end thereof is electrically connected to any or all of the positive electrode terminals 7 of the secondary batteries 100, while the other end protrudes beyond the opening 320 of the housing 310 and thus protrudes past the upper portion of the housing 310. Meanwhile, a negative electrode terminal 333 for output of the battery module 200 is belt-shaped, and one end thereof is electrically connected to any or all of the negative electrode terminals 6 of the secondary batteries 100, while the other end protrudes beyond the opening 320 of the housing 310 and thus protrudes past the upper portion of the housing 310.

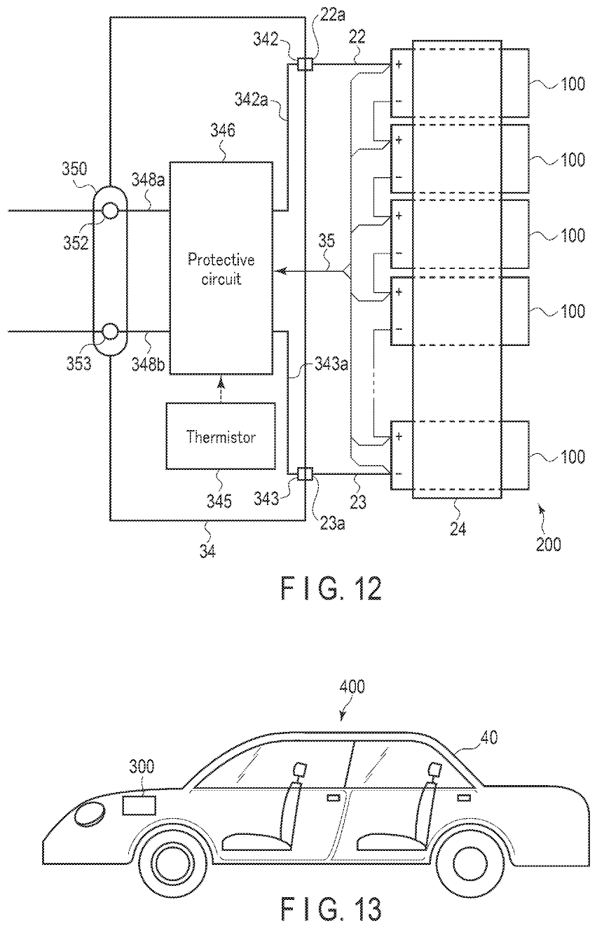

Another example of the battery pack is explained in detail with reference to FIG. 11 and FIG. 12. FIG. 11 is an exploded perspective view schematically showing another example of the battery pack according to the embodiment. FIG. 12 is a block diagram showing an example of an electric circuit of the battery pack shown in FIG. 11.

A battery pack 300 shown in FIGS. 11 and 12 includes a housing container 31, a lid 32, protective sheets 33, a battery module 200, a printed wiring board 34, wires 35, and an insulating plate (not shown).

The housing container 31 shown in FIG. 11 is a bottomed prismatic container having a rectangular bottom surface. The housing container 31 is configured to be capable of housing the protective sheets 33, the battery module 200, the printed wiring board 34, and the wires 35. The lid 32 has a rectangular shape. The lid 32 covers the housing container 31 to house the battery module 200 and such. Although not illustrated, the housing container 31 and the lid 32 are provided with openings, connection terminals, or the like for connection to an external device or the like.

The battery module 200 includes plural single-batteries 100, a positive electrode-side lead 22, a negative electrode-side lead 23, and adhesive tape(s) 24.

At least one of the plural single-batteries 100 is a secondary battery according to the first embodiment. The plural single-batteries 100 are electrically connected in series, as shown in FIG. 12. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape(s) 24 fastens the plural single-batteries 100. The plural single-batteries 100 may be fixed using a heat shrinkable tape in place of the adhesive tape(s) 24. In this case, protective sheets 33 are arranged on both side surfaces of the battery module 200, and the heat shrinkable tape is wound around the battery module 200 and protective sheets 33. After that, the heat shrinkable tape is shrunk by heating to bundle the plural single-batteries 100.

One end of the positive electrode-side lead 22 is connected to the battery module 200. The one end of the positive electrode-side lead 22 is electrically connected to the positive electrode(s) of one or more single-battery 100. One end of the negative electrode-side lead 23 is connected to the battery module 200. The one end of the negative electrode-side lead 23 is electrically connected to the negative electrode(s) of one or more single-battery 100.

The printed wiring board 34 is provided along one face in the short side direction among the inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side wiring (positive-side wiring) 348a, and a minus-side wiring (negative-side wiring) 348b. One principal surface of the printed wiring board 34 faces one side surface of the battery module 200. An insulating plate (not shown) is disposed in between the printed wiring board 34 and the battery module 200.

The other end 22a of the positive electrode-side lead 22 is electrically connected to the positive electrode-side connector 342. The other end 23a of the negative electrode-side lead 23 is electrically connected to the negative electrode-side connector 343.

The thermistor 345 is fixed to one principal surface of the printed wiring board 34. The thermistor 345 detects the temperature of each single-battery 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive-side terminal 352 and a negative-side terminal 353.

The protective circuit 346 is fixed to the other principal surface of the printed wiring board 34. The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the plural single-batteries 100 via the wires 35.

The protective sheets 33 are arranged on both inner surfaces of the housing container 31 along the long side direction and on an inner surface along the short side direction facing the printed wiring board 34 across the battery module 200. The protective sheets 33 are made of, for example, resin or rubber.

The protective circuit 346 controls charge and discharge of the plural single-batteries 100. The protective circuit 346 is also configured to cut-off electric connection between the protective circuit 346 and the external power distribution terminal 350 (positive-side terminal 352, negative-side terminal 353) to external device(s), based on detection signals transmitted from the thermistor 345 or detection signals transmitted from each single-battery 100 or the battery module 200.

An example of the detection signal transmitted from the thermistor 345 is a signal indicating that the temperature of the single-battery(s) 100 is detected to be a predetermined temperature or more. An example of the detection signal transmitted from each single-battery 100 or the battery module 200 include a signal indicating detection of over-charge, over-discharge, and overcurrent of the single-battery(s) 100. When detecting over-charge or the like for each of the single-batteries 100, the battery voltage may be detected, or a positive electrode potential or negative electrode potential may be detected. In the latter case, a lithium electrode to be used as a reference electrode may be inserted into each single-battery 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output electric current from the battery module 200 to an external device and input electric current from an external device to the battery module 200 via the external power distribution terminal 350. In other words, when using the battery pack 300 as a power source, the electric current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may be omitted. In this case, the positive electrode-side lead 22 and the negative electrode-side lead 23 may respectively be used as the positive-side terminal and negative-side terminal of the external power distribution terminal.

Such a battery pack is used, for example, in applications where excellent cycle performance is demanded when a large current is extracted. More specifically, the battery pack is used as, for example, a power source for electronic devices, a stationary battery, or an onboard battery for various kinds of vehicles. An example of the electronic device is a digital camera. The battery pack is particularly favorably used as an onboard battery.

The battery pack according to the third embodiment is provided with the secondary battery according to the first embodiment or the battery module according to the second embodiment. Accordingly, the battery pack can exhibit high charge-discharge efficiency.

### Fourth Embodiment

According to a fourth embodiment, a vehicle is provided. The vehicle has the battery pack according to the third embodiment installed thereon.

In the vehicle, the battery pack is configured, for example, to recover regenerative energy from motive force of the vehicle. The vehicle may include a mechanism (a regenerator) for converting kinetic energy of the vehicle into regenerative energy.

Examples of the vehicle include two-wheeled to four-wheeled hybrid electric automobiles, two-wheeled to four-wheeled electric automobiles, power assisted bicycles, and railway cars.

The installing position of the battery pack in the vehicle is not particularly limited. For example, when installing the battery pack in an automobile, the battery pack may be installed in the engine compartment of the vehicle, in rear parts of the vehicle, or under seats.

The vehicle may have plural battery packs installed thereon. In such a case, batteries included in each of the battery packs may be electrically connected to each other in series, electrically connected in parallel, or electrically connected in a combination of in-series connection and in-parallel connection. For example, in a case where each battery pack includes a battery module, the battery modules may be electrically connected to each other in series, electrically connected in parallel, or electrically connected in a combination of in-series connection and in-parallel connection. Alternatively, in a case where each battery pack includes a single battery, each of the batteries may be electrically connected to each other in series, electrically connected in parallel, or electrically connected in a combination of in-series connection and in-parallel connection.

Next, an example of the vehicle according to the embodiment will be described with reference to the drawings.

FIG. 13 is a partially see-through diagram schematically showing an example of a vehicle according to the embodiment.

The vehicle 400 shown in FIG. 13 includes a vehicle body 40 and a battery pack 300 according to the third embodiment. In the example shown in FIG. 13, the vehicle 400 is a four-wheeled automobile.

This vehicle 400 may have plural battery packs 300 installed. In such a case, the batteries (single-batteries or battery modules) included in the battery packs 300 may be connected in series, connected in parallel, or connected in a combination of in-series connection and in-parallel connection.

In FIG. 13, given is an example where the battery pack 300 is installed in an engine compartment located at the front of the vehicle body 40. As described above, the battery pack 300 may be installed in rear sections of the vehicle body 40, or under a seat. The battery pack 300 may be used as a power source of the vehicle 400. In addition, the battery pack 300 can recover regenerative energy of a motive force of the vehicle 400.

The vehicle according to the fourth embodiment has the battery pack according to the third embodiment installed therein. Therefore, the vehicle is excellent in drive performance.

### Fifth Embodiment

According to a fifth embodiment, a stationary power supply is provided. The stationary power supply has the battery pack according to the third embodiment installed therein.

The stationary power supply may have the battery module according to the second embodiment or the secondary battery according to the first embodiment installed therein, instead of the battery pack according to the third embodiment. The stationary power supply according to the embodiment can realize high efficiency and high life.

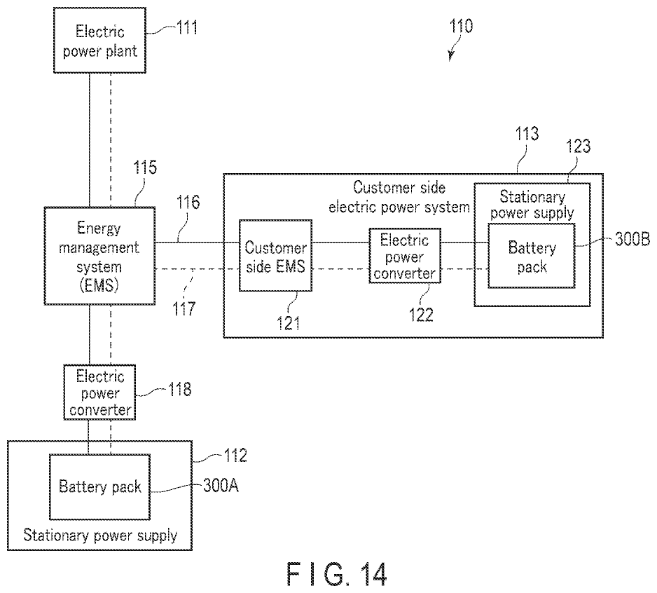

FIG. 14 is a block diagram showing an example of a system including the stationary power supply according to the embodiment. FIG. 14 is a diagram showing an application example to stationary power supplies 112, 123 as an example of use of battery packs 300A, 300B according to the third embodiment. In the example shown in FIG. 14, shown is a system 110 in which the stationary power supplies 112, 123 are used. The system 110 includes an electric power plant 111, the stationary power supply 112, a customer side electric power system 113, and an energy management system (EMS) 115. Moreover, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control to stabilize the entire system 110 by utilizing the electric power network 116 and the communication network 117.

The electric power plant 111 generates a large capacity of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current (DC) and alternate current (AC), conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

Note that the electric power stored in the battery pack 300B can be used, for example, for charging a vehicle such as an electric automobile. Also, the system 110 may be provided with a natural energy source. In such a case, the natural energy source generates electric power by natural energy such as wind power and solar light. In addition to the electric power plant 111, electric power is also supplied from the natural energy source through the electric power network 116.

### EXAMPLES

Examples will be described below, but the embodiments are not limited to the examples described below.

### Example 1

As a negative electrode active material, particles of niobium titanium oxide having a monoclinic structure and having a composition represented by the formula TiNb₂O₇ were prepared. This niobium titanium oxide having a monoclinic structure has a composition represented by LiₓTiNb₂O₇ (0≤x≤5) in a battery. Acetylene black was prepared as an electro-conductive agent, and carboxymethyl cellulose (CMC) and styrene-butadiene rubber (SBR) were prepared as a water-containing binder. These were mixed in pure water in such a manner that the mass ratio (mass %) of the negative electrode active material:acetylene black:carboxymethyl cellulose:styrene butadiene rubber was 95:4.2:0.4:0.4 to obtain a slurry. The slurry was applied onto a current collector made of an aluminum foil having a thickness of 15 μm, and the coating film was dried. Thus, a composite containing the current collector and the negative electrode active material-containing layer formed on the current collector was obtained. Then, the obtained composite was subjected to roll pressing. Next, this composite was further subjected to vacuum drying to yield a negative electrode.

### <Production of Positive Electrode>

As a positive electrode active material, particles of a lithium-nickel-cobalt-manganese composite oxide represented by the formula LiNi_{0.33}Co_{0.33}Mn_{0.33}O₂ (hereinafter referred to as NCM111) were prepared. In addition, acetylene black as an electro-conductive agent and polyvinylidene fluoride (PVdF) as a binder were prepared. These were mixed in such a manner that the mass ratio (mass %) of the positive electrode active material:electro-conductive agent:binder was 90:5:5 to obtain a mixture. Next, the obtained mixture was dispersed in an n-methylpyrrolidone (NMP) solvent to prepare a positive electrode slurry. The slurry was applied onto a current collector made of an aluminum foil having a thickness of 15 μm, and the coating film was dried. Thus, a composite containing the current collector and the positive electrode active material-containing layer formed on both surfaces of the current collector was obtained. Then, the obtained composite was subjected to roll pressing. Next, this composite was further subjected to vacuum drying to yield a positive electrode.

### <Production of Electrode Group>

Each of the positive electrode and the negative electrode was cut out in such a manner that the area where the active material-containing layer was formed was 3 cm in width and 5 cm in height. One negative electrode and one positive electrode were bonded together with a 30 μm-thick cellulose separator interposed therebetween to produce an electrode stack as an electrode group. In order to collect current, an aluminum tab having a thickness of 0.2 mm was attached to each of the negative electrode and the positive electrode.

### <Preparation of Electrolyte>

LiTFSI was dissolved in trimethyl phosphate (TMP) so as to achieve 30 mass % of LiN(CF₃SO₂)₂ (LiTFSI) and 70 mass % of TMP, to obtain an electrolyte solution. To the obtained electrolyte solution, 170 ppm by mass of water (H₂O) was added and further mixed to prepare a liquid electrolyte (electrolytic solution).

### <Assembly of Battery>

The produced electrode stack was housed in a container member made of a laminate film. Next, the liquid electrolyte was put into the container member. The liquid electrolyte was put-in under an environment of a dew point of negative 15° C. Thereafter, the container member was sealed to yield the secondary battery.

The obtained secondary battery was subjected to initial charge and discharge at 25° C. and a constant current of 0.2 C.

### Example 2

A secondary battery was obtained in the same manner as in Example 1 except that water was added in an amount of 200 ppm (mass ratio) to a nonaqueous electrolyte solution of 38 mass % of LiTFSI and 62 mass % of TMP in preparation of the liquid electrolyte.

### Example 3

A secondary battery was obtained in the same manner as in Example 1 except that water was added in an amount of 29400 ppm (mass ratio) to a nonaqueous electrolyte solution of 70 mass % of LiTFSI and 30 mass % of TMP in preparation of the liquid electrolyte.

### Example 4

A secondary battery was obtained in the same manner as in Example 1 except that water was added in an amount of 250 ppm (mass ratio) to a nonaqueous electrolyte solution of 45 mass % of LiTFSI, 5 mass % of LiB(C₂O₄)₂ (LiBOB), and 50 mass % of TMP in preparation of the liquid electrolyte.

### Example 5

A secondary battery was obtained in the same manner as in Example 1 except that water was added in an amount of 250 ppm (mass ratio) to a nonaqueous electrolyte solution of 45 mass % of LiTFSI, 5 mass % of LiBF₂(C₂O₄) (LiDFOB), and 50 mass % of TMP in preparation of the liquid electrolyte.

### Example 6

A secondary battery was obtained in the same manner as in Example 5 except that triethyl phosphate (TEP) was used instead of TMP.

### Example 7

A secondary battery was obtained in the same manner as in Example 5 except that the monoclinic titanium oxide TiO₂ (B) was used as the negative electrode active material instead of TiNb₂O₇.

### Example 8

A secondary battery was obtained in the same manner as in Example 5 except that spinel structured lithium titanate Li₄Ti₅O₁₂ was used as the negative electrode active material instead of TiNb₂O₇.

### Example 9

A secondary battery was obtained in the same manner as in Example 5 except that LiNi_{0.6}Co_{0.2}Mn_{0.2}O₂ (hereinafter referred to as NCM622) was used as the positive electrode active material instead of NCM111.

### Example 10

A secondary battery was obtained in the same manner as in Example 5 except that LiNi_{0.8}Co_{0.1}Mn_{0.1}O₂ (hereinafter referred to as NCM811) was used as the positive electrode active material instead of NCM111.

### Example 11

A secondary battery was obtained in the same manner as in Example 5 except that LiAl_{0.2}Mn_{1.8}O₄ (hereinafter, referred to as LMO) was used as the positive electrode active material instead of NCM111.

### Example 12

A secondary battery was obtained in the same manner as in Example 5 except that LiMn_{0.7}Fe_{0.3}PO₄ (hereinafter referred to as LMFP) was used as the positive electrode active material instead of NCM111.

### Example 13

A secondary battery was obtained in the same manner as in Example 1 except that a negative electrode using graphite as the negative electrode active material instead of TiNb₂O₇ was produced, and a liquid electrolyte to which an additive was added was prepared. Specifically, the negative electrode was produced with the slurry composition set to a mass ratio (mass %) where graphite:CMC:SBR was 98:1.0:1.0, and using a copper foil as the current collector. The liquid electrolyte was prepared by adding 250 ppm of water to a nonaqueous electrolyte solution having a composition with 44 mass % LiTFSI, 4 mass % LiDFOB, 50 mass % TMP, 1 mass % vinylene carbonate (VC), and 1 mass % fluoroethylene carbonate (FEC).

### Example 14

A secondary battery was obtained in the same manner as in Example 13 except that a negative electrode using silicon monoxide (Si) as the negative electrode active material together with graphite instead of the graphite alone was produced. Specifically, the negative electrode was produced with the slurry composition set to a mass ratio (mass %) where graphite:SiO:CMC:SBR was 94:4.0:1.0:1.0, and using a copper foil as the current collector.

### Example 15

A secondary battery was obtained in the same manner as in Example 1 except that water was added in an amount of 250 ppm (mass ratio) to a nonaqueous electrolyte solution of 45 mass % of LiTFSI, 5 mass % of LiDFOB, 45 mass % of TMP, and 5 mass % of succinonitrile in preparation of the liquid electrolyte.

### Example 16

A secondary battery was obtained in the same manner as in Example 1 except that water was added in an amount of 250 ppm (mass ratio) to a nonaqueous electrolyte solution of 45 mass % of LiTFSI, 5 mass % of LiDFOB, 45 mass % of TMP, and 5 mass % of sulfolane in preparation of the liquid electrolyte.

### Comparative Example 1

A secondary battery was obtained in the same manner as in Example 1 except that water was added in an amount of 20 ppm (mass ratio) to a nonaqueous electrolyte solution of 70 mass % of LiTFSI and 30 mass % of TMP in preparation of the liquid electrolyte.

### Comparative Example 2

A secondary battery was obtained in the same manner as in Example 1 except that water was added in an amount of 33,000 ppm (mass ratio) to a nonaqueous electrolyte solution of 70 mass % of LiTFSI and 30 mass % of TMP in preparation of the liquid electrolyte.

### Comparative Example 3

A secondary battery was obtained in the same manner as in Example 1 except that water was added in an amount of 170 ppm (mass ratio) to a nonaqueous electrolyte solution of 15 mass % of lithium hexafluorophosphate (LiPF₆) and 85 mass % of TMP in preparation of the liquid electrolyte.

### Comparative Example 4

A secondary battery was obtained in the same manner as in Example 1 except that an aqueous solution of 85.8 mass % of LiTFSI and 14.2 mass % of water was prepared in preparation of the liquid electrolyte, in order to obtain a composition known as a 21 mol/kg LiTFSI aqueous solution.

### <Measurements>

The battery subjected to the initial charge-discharge was disassembled according to the procedure described above, and the negative electrode was taken out and washed. The surface of the negative electrode was subjected to XPS analysis under the conditions described above to examine the elements contained in the surface of the negative electrode. The confirmed contained elements are shown in Table 1.

Table 1 summarizes the composition of each member in the batteries produced in Examples 1 to 16 and Comparative examples 1 to 4. Specifically, Table 1 shows the negative electrode active material, the positive electrode active material, the liquid electrolyte (electrolytic solution) composition, and contained elements observed in the surface of the negative electrode. The compound name of the positive electrode active material is indicated by the above-mentioned abbreviation (for example, LiNi_{0.33}Co_{0.33}Mn_{0.33}O₂ is presented as NCM111). Each component of the liquid electrolyte composition is also abbreviated. In addition, the content of the phosphate ester and the water content in the liquid electrolyte are shown.

TABLE 1

| | | | | Amount of | Water | |
|---|---|---|---|---|---|---|
| | Negative | Positive | Compositional components | phosphate | content | Contained |
| | electrode | electrode | in electrolytic solution | ester | (Mass ratio) | element |
| Example 1 | TiNb₂O₇ | NCM111 | LiTFSI + TMP | 70 mass % | 170 ppm | F, P |
| Example 2 | TiNb₂O₇ | NCM111 | LiTFSI + TMP | 62 mass % | 200 ppm | F, P |
| Example 3 | TiNb₂O₇ | NCM111 | LiTFSI + TMP | 30 mass % | 29400 ppm | F, P |
| Example 4 | TiNb₂O₇ | NCM111 | LiTFSI + LiBOB + TMP | 50 mass % | 250 ppm | F, P, B |
| Example 5 | TiNb₂O₇ | NCM111 | LiTFSI + LiDFOB + TMP | 50 mass % | 250 ppm | F, P, B |
| Example 6 | TiNb₂O₇ | NCM111 | LiTFSI + LiDFOB + TEP | 50 mass % | 250 ppm | F, P, B |
| Example 7 | TiO₂ (B) | NCM111 | LiTFSI + LiDFOB + TMP | 50 mass % | 250 ppm | F, P, B |
| Example 8 | Li₄Ti₅O₁₂ | NCM111 | LiTFSI + LiDFOB + TMP | 50 mass % | 250 ppm | F, P, B |
| Example 9 | TiNb₂O₇ | NCM622 | LiTFSI + LiDFOB + TMP | 50 mass % | 250 ppm | F, P, B |
| Example 10 | TiNb₂O₇ | NCM811 | LiTFSI + LiDFOB + TMP | 50 mass % | 250 ppm | F, P, B |
| Example 11 | TiNb₂O₇ | LMO | LiTFSI + LiDFOB + TMP | 50 mass % | 250 ppm | F, P, B |
| Example 12 | TiNb₂O₇ | LMFP | LiTFSI + LiDFOB + TMP | 50 mass % | 250 ppm | F, P, B |
| Example 13 | Graphite | NCM111 | LiTFSI + LiDFOB + TMP + VC + FEC | 50 mass % | 250 ppm | F, P, B |
| Example 14 | Graphite + SiO | NCM111 | LiTFSI + LiDFOB + TMP + VC + FEC | 50 mass % | 250 ppm | F, P, B |
| Example 15 | TiNb₂O₇ | NCM111 | LiTFSI + LiDFOB + TMP + succinonitrile | 50 mass % | 250 ppm | F, P, B, N |
| Example 16 | TiNb₂O₇ | NCM111 | LiTFSI + LiDFOB + TMP + sulfolane | 50 mass % | 250 ppm | F, P, B, S |
| Comparative | TiNb₂O₇ | NCM111 | LiTFSI + TMP | 30 mass % | 20 ppm | F, P |
| Example 1 | | | | | | |
| Comparative | TiNb₂O₇ | NCM111 | LiTFSI + TMP | 30 mass % | 33000 ppm | F |
| Example 2 | | | | | | |
| Comparative | TiNb₂O₇ | NCM111 | LiPE₆ + TMP | 85 mass % | 170 ppm | F |
| Example 3 | | | | | | |
| Comparative | TiNb₂O₇ | NCM111 | 21 mol/kg LiTFSI aqueous solution | — | Solvent Main | Absent |
| Example 4 | | | (water with salt dissolved therein) | | component | |

### <Evaluation>

Each battery was subjected to a charge and discharge cycle test. The test conditions were as follows. 0.5 C cycles were performed in an environment of 25° C., and the capacity retention ratio at the 100th cycle and the charge-discharge efficiency at the 50th cycle were determined. As the capacity retention ratio, the ratio of the capacity at the 100th cycle to the capacity at the 1st cycle was calculated.

The results of the cycle test are summarized in the following Table 2.

TABLE 2

| | Charge- | Capacity |
|---|---|---|
| | discharge | retention |
| | efficiency | ratio |
| | (%) | (%) |
| Example 1 | 99.5 | 90 |
| Example 2 | 99.4 | 90 |
| Example 3 | 99.3 | 87 |
| Example 4 | 99.6 | 91 |
| Example 5 | 99.6 | 92 |
| Example 6 | 99.4 | 90 |
| Example 7 | 99.5 | 90 |
| Example 8 | 99.7 | 93 |
| Example 9 | 99.3 | 90 |
| Example 10 | 99.3 | 88 |
| Example 11 | 99.5 | 91 |
| Example 12 | 99.2 | 91 |
| Example 13 | 99.2 | 86 |
| Example 14 | 99.2 | 83 |
| Example 15 | 99.6 | 93 |
| Example 16 | 99.6 | 92 |
| Comparative | 98.8 | 85 |
| Example 1 | | |
| Comparative | 98.5 | 80 |
| Example 2 | | |
| Comparative | 97.9 | 78 |
| Example 3 | | |
| Comparative | 97.0 | 74 |
| Example 4 | | |

As shown in Table 2, the batteries produced in Examples 1 to 16 had both a higher capacity retention ratios at the 100th cycle and a higher charge-discharge efficiency at the 50th cycle, than the batteries produced in Comparative Examples 1 to 4. For Comparative example 1, it is considered that, since the water content in the electrolyte was extremely small, a sufficient covering film could not be formed on the negative electrode and the negative electrode could not be protected. For Comparative example 2, it is presumed that the battery performance was deteriorated due to too much water. For Comparative example 3, it is determined that, since LiPF₆ was used as a lithium salt in the electrolyte, water and LiPF₆ reacted with each other to generate a large amount of HF, and therefore the crystal structure of the positive electrode was deteriorated and/or a covering film for appropriately protecting the negative electrode was not formed. In Comparative example 4, the battery performance was particularly low because the solution with water being its main component was used as the solvent of the electrolyte. In Examples 13 and 14, unlike the other Examples, a graphite negative electrode is used instead of a titanium-containing oxide negative electrode. Since the graphite negative electrode is inferior in cycle performance to the titanium-containing oxide negative electrode, the capacity retention ratio is slightly lower than that of the other examples.

According to at least one embodiment and example described above, a secondary battery is provided. The secondary battery includes a negative electrode, a positive electrode, and an electrolyte. The electrolyte contains a phosphate ester, 150 ppm to 30,000 ppm of water in terms of mass, and at least one lithium salt selected from the group consisting of lithium bis(trifluoromethanesulfonyl) imide, lithium bis(fluorosulfonyl) imide, lithium difluorooxalate borate, lithium bisoxalate borate, and lithium triflate. As the secondary battery is capable of suppressing electrolysis of water at the negative electrode, the secondary battery exhibits high charge-discharge efficiency. Further, the secondary battery can provide a battery pack exhibiting high charge-discharge efficiency, and moreover, a vehicle and stationary power supply having the battery pack installed thereon.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Several embodiments relevant to the present disclosure are given below.
1. A secondary battery comprising:
a negative electrode;
a positive electrode; and
an electrolyte containing water, a lithium salt, and a phosphate ester,
the electrolyte containing the water in an amount of 150 ppm or more and 30,000 ppm or less in terms of mass, and the lithium salt including at least one selected from a group consisting of lithium bis(trifluoromethanesulfonyl) imide, lithium bis(fluorosulfonyl) imide, lithium difluorooxalate borate, lithium bisoxalate borate, and lithium triflate.
2. The secondary battery according to clause 1, wherein the electrolyte contains at least one selected from a group consisting of a nitrile compound, an isocyanate compound, a compound having an amide group, a carbonate ester, and a fluorinated carbonate ester.
3. The secondary battery according to clause 1 or 2, wherein the negative electrode contains at least one element selected from a group consisting of F, P, B, N, and S on a surface thereof.
4. The secondary battery according to any one of clauses 1 to 3, wherein the electrolyte contains 30 mass % or more and 70 mass % or less of the phosphate ester.
5. The secondary battery according to any one of clauses 1 to 4, wherein the negative electrode contains at least one titanium-containing oxide selected from a group consisting of titanium oxide, lithium titanium oxide, monoclinic niobium titanium oxide, and orthorhombic titanium-containing composite oxide.
6. The secondary battery according to any one of clauses 1 to 4, wherein the negative electrode contains at least one selected from a group consisting of graphite, hard carbon, and a silicon-containing compound.
7. A battery pack comprising the secondary battery according to any one of clauses 1 to 6.
8. The battery pack according to clause 7, further comprising an external power distribution terminal and a protective circuit.
9. The battery pack according to clause 7 or 8, further comprising plural of the secondary battery, the secondary batteries being electrically connected in series, in parallel, or in combination of in-series connection and in-parallel connection.
10. A vehicle comprising the battery pack according to any one of clauses 7 to 9.
11. The vehicle according to claim 10, which comprises a mechanism configured to convert kinetic energy of the vehicle into regenerative energy.
12. A stationary power supply comprising the battery pack according to any one of clauses 7 to 9.
13. A method for producing the secondary battery according to any one of clauses 1 to 6, the method comprising:
preparing the negative electrode;
preparing the positive electrode;
preparing the electrolyte;
preparing a container member;
housing the negative electrode and the positive electrode in the container member; and
putting in the electrolyte into the container member,
the putting in the electrolyte being performed under an environment of a dew point of −20° C. or more and 0° C. or less.

What is claimed is:

1. A secondary battery comprising:
a negative electrode;
a positive electrode; and
an electrolyte containing water, a lithium salt, and a phosphate ester,
the electrolyte containing the water in an amount of 150 ppm or more and 30,000 ppm or less in terms of mass, and the lithium salt including at least one selected from a group consisting of lithium bis(trifluoromethanesulfonyl) imide, lithium bis(fluorosulfonyl) imide, lithium difluorooxalate borate, lithium bisoxalate borate, and lithium triflate.

2. The secondary battery according to claim 1, wherein the electrolyte contains at least one selected from a group consisting of a nitrile compound, an isocyanate compound, a compound having an amide group, a carbonate ester, and a fluorinated carbonate ester.

3. The secondary battery according to claim 1, wherein the negative electrode contains at least one element selected from a group consisting of F, P, B, N, and S on a surface thereof.

4. The secondary battery according to claim 1, wherein the electrolyte contains 30 mass % or more and 70 mass % or less of the phosphate ester.

5. The secondary battery according to claim 1, wherein the negative electrode contains at least one titanium-containing oxide selected from a group consisting of titanium oxide, lithium titanium oxide, monoclinic niobium titanium oxide, and orthorhombic titanium-containing composite oxide.

6. The secondary battery according to claim 1, wherein the negative electrode contains at least one selected from a group consisting of graphite, hard carbon, and a silicon-containing compound.

7. A battery pack comprising the secondary battery according to claim 1.

8. The battery pack according to claim 7, further comprising an external power distribution terminal and a protective circuit.

9. The battery pack according to claim 7, further comprising plural of the secondary battery, the secondary batteries being electrically connected in series, in parallel, or in combination of in-series connection and in-parallel connection.

10. A vehicle comprising the battery pack according to claim 7.

11. The vehicle according to claim 10, which comprises a mechanism configured to convert kinetic energy of the vehicle into regenerative energy.

12. A stationary power supply comprising the battery pack according to claim 7.

13. A method for producing the secondary battery according to claim 1, the method comprising:
preparing the negative electrode;
preparing the positive electrode;
preparing the electrolyte;
preparing a container member;
housing the negative electrode and the positive electrode in the container member; and
putting in the electrolyte into the container member,
the putting in the electrolyte being performed under an environment of a dew point of −20° C. or more and 0° C. or less.
